(19) United States
(12) Patent Application Publication
(10) Pub. No.: US 2026/0093209 A1
(43) Pub. Date: Apr. 2, 2026

(54) WATCH COMPRISING A HOROLOGY MOVEMENT COMPRISING A MOON PHASE DISPLAY DEVICE AND AN EARTH PHASE DISPLAY DEVICE

(71) Applicant: ETA SA MANUFACTURE HORLOGÈRE SUISSE, Grenchen (CH)

(72) Inventors: Gregory KISSLING, La Neuveville (CH); Adrien KELLER, Neuchâtel (CH)

(73) Assignee: ETA SA MANUFACTURE HORLOGÈRE SUISSE, Grenchen (CH)

(21) Appl. No.: 19/307,312

(22) Filed: Aug. 22, 2025

(30) Foreign Application Priority Data
Sep. 27, 2024 (EP) 24203283.7

(51) Int. Cl. G04B 19/26

(52) U.S. Cl. CPC G04B 19/268

(57) ABSTRACT

A watch (10) including a dial (13) and a horology movement (100) including a Moon phase display device (11), an Earth phase display device (12), the Earth phase display device (12) including a graphical representation of the Earth (120) immovably arranged relative to the dial (13) and facing a first aperture (130) made in the dial (13), a mask (123) rotated by a drive organ and interposed between the graphical representation of the Earth (120) and the dial (13), the Moon phase display device (11) including a display (110) arranged facing a second aperture (131) formed in the dial (13) and rotated relative to the dial (13) by a drive organ, the display (110) including two graphical representations of the Moon (111).

### CROSS REFERENCE TO RELATED APPLICATIONS

This application claims priority to European Patent Application No. 24203283.7 filed September 27, 2024, the entire contents of which are incorporated herein by reference.

### TECHNICAL FIELD OF THE INVENTION

The invention relates to the field of horology and in particular to devices for displaying a time value on a timepiece.

More specifically, the invention relates to a watch comprising a horology movement comprising a Moon phase display device and an Earth phase display device.

### Technological background

Moon phase displays are quite common in the field of horology, as are Earth phase displays, in other words displays of the part of the Earth visible from the Moon.

Moon or Earth phase display devices considerably complicate the horology movement into which they are incorporated.

In addition, for aesthetic reasons, it may be desirable to display the phases of the Moon and Earth at the same time.

The invention addresses this need, while simplifying the kinematics to the greatest extent possible for simultaneous display of the phases of the Moon and Earth.

### SUMMARY OF THE INVENTION

To this end, the invention relates to a watch comprising a dial and a horology movement comprising a Moon phase display device and an Earth phase display device.

The Earth phase display device comprises a graphical representation of the Earth arranged immovably relative to the dial and facing a first aperture in the dial, and a mask rotated by a drive organ and interposed between the graphical representation of the Earth and the dial.

The Moon phase display device comprises a display arranged facing a second aperture formed in the dial and rotated relative to the dial by a drive organ, the display comprising two graphic representations of the Moon.

In particular embodiments, the invention can further comprise one or more of the following features, taken separately or in any technically possible combination.

In particular embodiments, the mask and the display are moved by two separate drive organs formed respectively by an electric motor designed to be powered by a source of electricity.

In particular embodiments, the mask and the display are moved by the same drive organ formed by an electric motor intended to be powered by a source of electricity.

In particular embodiments, the mask and the display are moved by the same drive organ formed by a barrel kinematically connected to a regulating organ.

In particular embodiments, the mask of the Earth phase display device has two masking elements arranged diametrically opposite each other and extending along a longitudinal axis between a first end by which they are rotated and a second free end.

In particular embodiments, each masking element comprises two lateral rims that are symmetrical relative to the longitudinal axis, each forming a lobe.

In particular embodiments, the lobes have a tip that has an orthogonal projection on the longitudinal axis that is closer to the first end of the masking element than to the second end.

In particular embodiments, the graphical representation of the Earth is produced on a rest in the form of a disc attached with no degree of freedom, for example glued to a structure on the horology movement.

In particular embodiments, the mask is permanently rotationally attached to an Earth phase pipe, to which is attached a pipe wheel meshing with a drive mobile via an intermediate wheel, said drive mobile comprising a pivot shank on which the Earth phase pipe is fitted so as to rotate freely.

In particular embodiments, the display on the Moon phase display device and the mask on the Earth phase display device are rotated in opposite directions.

### BRIEF DESCRIPTION OF THE FIGURES

Other features and advantages of the invention will become apparent from the following detailed description, given by way of non-limiting example, with reference to the attached drawings in which:

FIG. 1 shows a front view of a watch comprising a device for displaying a Moon phase and an Earth phase according to a preferred exemplary embodiment of the invention,

FIG. 2 shows an exploded perspective view of certain components of the watch in FIG. 1,

FIG. 3 shows a cross-sectional view along an axis A-A of the watch in FIG. 1,

FIG. 4 shows a perspective view of a mask of the Earth phase display device in FIG. 1.

It should be noted that the figures are not necessarily drawn to scale for clarity reasons.

### DETAILED DESCRIPTION OF THE INVENTION

The present invention relates to a watch 10 comprising a horology movement 100 comprising a Moon phase display device 11 and an Earth phase display device 12.

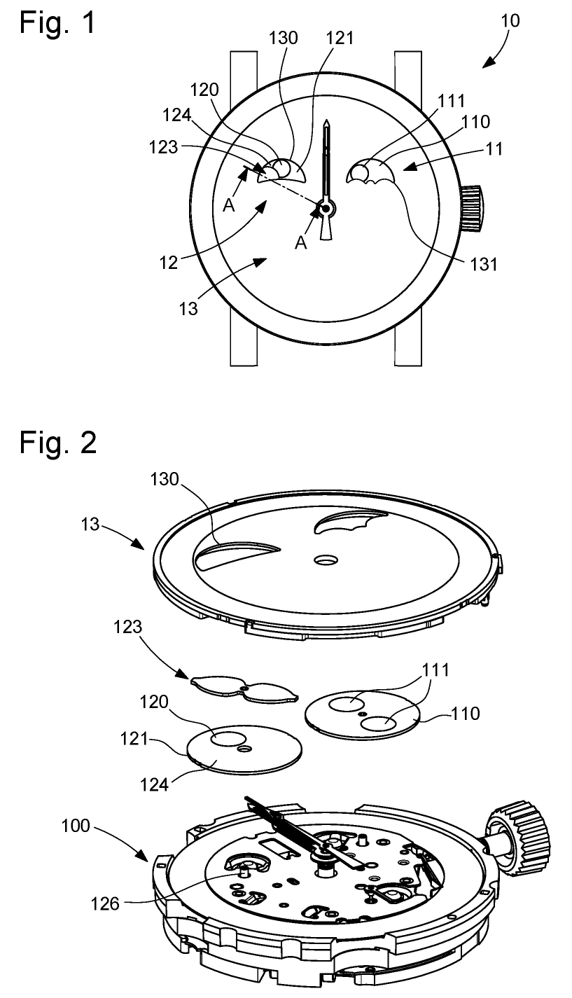

The watch 10 is also provided with a dial 13 in which a first and a second aperture 130 and 131 are respectively designed to show an Earth phase and a Moon phase, as can be seen in the front view in FIG. 1.

The Earth phase display device 12 comprises a graphical representation of the Earth 120 arranged immovably relative to the dial 13 and facing the first aperture 130. In the exemplary embodiment of the invention shown in the figures, the graphical representation of the Earth 120 is produced on a rest 121 in the form of a disc and the first aperture 130 has a substantially semi-circular shape. It should be generally noted that the rest 121 is in the form of a plate, the outline of which can be in any suitable geometric shape. The rest 121 is attached with no degree of freedom, preferentially glued, for example, using an adhesive film 122, to a structure on the horology movement 100. Assembling the Earth phase display device 12 in the horology movement 100 can therefore be easily industrialised.

The Earth phase display device 12 further comprises a mask 123 interposed between the graphical representation 120 of the Earth and the dial 13.

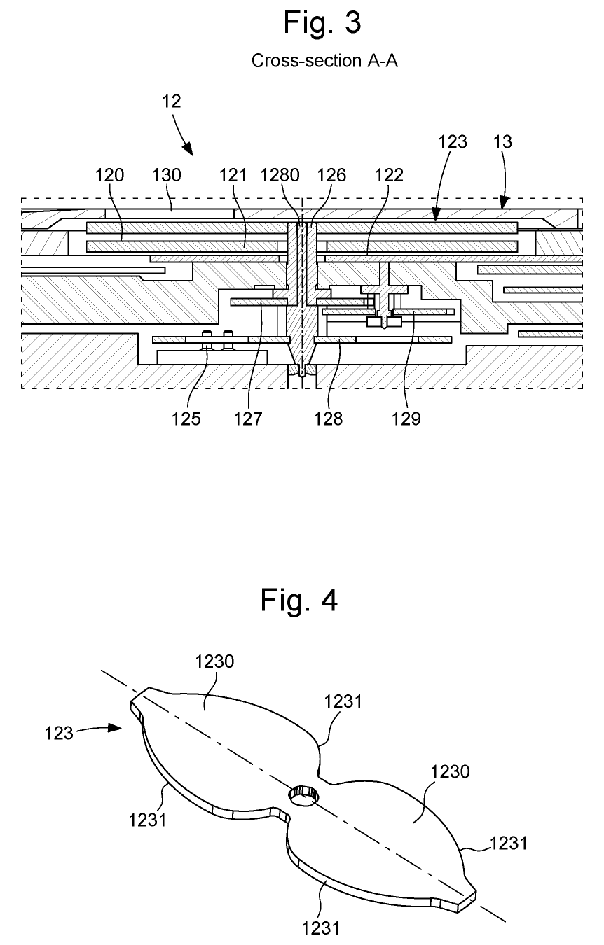

The mask 123 is arranged so as to be rotated by a drive organ to conceal the graphical representation of the Earth 120. Such a drive organ is preferentially formed by a first electric motor 125, the exit of which can be seen in the cross-sectional view in FIG. 3.

Advantageously, the graphical representation of the Earth 120 is produced on a back 124, the appearance of which is identical to that of the mask 123. For example, the back 124 and the mask 123 have an identical solid colour.

In a preferred exemplary embodiment, as shown in FIG. 3, the mask 123 can be driven in on an Earth phase pipe 126, to which a pipe wheel 127 is attached. The pipe wheel 127 meshes with a drive mobile 128 via an intermediate wheel 129. The drive mobile 128 is preferentially directly joined to the first electric motor 125 and comprises a pivot shank 1280 on which the Earth phase pipe 126 is fitted with a sliding fit. In other words, the mask 123 is permanently attached such that it rotates with the pipe 126, which is free to pivot relative to the pivot shank 1280.

Advantageously, the Moon phase display device 11 comprises a display 110 arranged facing the second aperture 131 and rotationally mobile relative to the dial 13. The display 110 comprises two diametrically opposed graphical representations of the Moon 111. The display 110 is preferentially in the form of a disc, as shown in the exploded view in FIG. 2. The second aperture 131 is shaped such that the dial constitutes, in a manner known per se, a mask behind which the display 110 can be concealed when it rotates.

Accordingly, the Earth phase and Moon phase are visible through two separate apertures that enhance the decoration of the watch 10.

The display 110 on the Moon phase display device 11 is rotated by a drive organ preferentially formed by a second electric motor, different from the first electric motor 125 connected to the mask 123. As a result, the drive for the Moon phase display and the drive for the Earth phase display are separate from each other. This characteristic is particularly advantageous because it enables the Moon and Earth phase displays to be set separately.

The electric motors driving the mask 123 and the display 110 of the Moon phase display device 11 are designed to be powered by a source of electricity, preferentially provided by the same electric cell.

It should be noted that the watch 10 according to the present invention can advantageously comprise an electric motor designed to power each function with which the watch 10 is equipped, such as the current time indication, a chronograph function, the indication of an additional time zone, a date indicator, etc.

FIGS. 2 and 4 show a preferred exemplary embodiment of the mask 123, in which the mask has two identical masking elements 1230 diametrically opposite each other. Each masking element 1230 has an elongated shape and extends along a longitudinal axis between a first end by which it is rotated and a second end, which is a free end.

Each masking element 1230 comprises two lateral rims that are symmetrical relative to the longitudinal axis, each forming a lobe 1231.

As can be seen in FIG. 4 in particular, the lobes 1231 have a tip that has an orthogonal projection on the longitudinal axis that is closer to the first end of the masking element 1230 than to the second end. The tip is defined as the point on each lateral rim furthest from the longitudinal axis.

These characteristics make it possible to reproduce as faithfully as possible the projection of the Moon's shadow on the Earth, when the mask 123 partially or completely covers the graphical representation of the Earth 120.

To show the Moon and Earth phases as accurately as possible and to make the appearance of the watch 10 as attractive as possible, the display 110 on the Moon phase display device 11 and the mask 123 on the Earth phase display device 12 are rotated in opposite directions.

In particular, in the preferred exemplary embodiment, the first and second electric motors are controlled by an electronic circuit to which they are connected, known as such to the person skilled in the art.

It should be noted that, for the sake of clarity, the components of the horology movement 100 known to the person skilled in the art are not described in this present text and do not appear in the figures.

Moreover, it should be noted that the embodiments and uses considered above have been described by way of non-limiting examples, and that other variants are therefore conceivable.

In particular, the mask 123 and the display 110 can be moved by the same electric motor designed to be powered by an electricity source that may or may not be shared.

In addition, alternatively, the mask 123 and the display 110 can be moved by the same drive organ formed by a barrel kinematically connected to a regulating organ.

In the last two examples referenced above, the display 110 of the Moon phase display device 11 and the mask 123 of the Earth phase display device 12 can be rotated in opposite directions by a rotationally mobile intermediate wheel arranged in the kinematic chain, which can easily be incorporated by a person skilled in the art.

1. A watch (10) comprising a dial (13) and a horology movement (100) comprising a Moon phase display device (11), an Earth phase display device (12), wherein the Earth phase display device (12) comprises a graphical representation of the Earth (120) immovably arranged relative to the dial (13) and facing a first aperture (130) made in the dial (13), a mask (123) rotated by a drive organ and interposed between the graphical representation of the Earth (120) and the dial (13), the Moon phase display device (11) comprising a display (110) arranged facing a second aperture (131) formed in the dial (13) and rotated relative to the dial (13) by a drive organ, the display (110) comprising two graphical representations of the Moon (111).

2. The watch (10) according to claim 1, wherein the mask (123) and the display (110) are moved by two separate drive organs formed respectively by an electric motor designed to be powered by a source of electricity.

3. The watch (10) according to claim 1, wherein the mask (123) and the display (110) are moved by the same drive organ formed by an electric motor intended to be powered by a source of electricity.

4. The watch (10) according to claim 1, wherein the mask (123) and the display (110) are moved by the same drive organ formed by a barrel kinematically connected to a regulating organ.

5. The watch (10) according to claim 1, wherein the mask (123) of the Earth phase display device (12) has two masking elements (1230) arranged diametrically opposite each other and extending along a longitudinal axis between a first end by which they are rotated and a second free end, each masking element (1230) comprising two lateral rims that are symmetrical relative to the longitudinal axis, each forming a lobe (1231).

6. The watch (10) according to claim 5, wherein the lobes (1231) have a tip that has an orthogonal projection on the longitudinal axis that is closer to the first end of the masking element (1230) than to the second end.

7. The watch (10) according to claim 1, wherein the graphical representation of the Earth (120) is produced on a rest (121) in the form of a disc attached with no degree of freedom to a structure on the horology movement (100).

8. The watch (10) according to claim 1, wherein the mask (123) is permanently rotationally attached to an Earth phase pipe (126), to which is attached a pipe wheel (127) meshing with a drive mobile (128) via an intermediate wheel (129), said drive mobile (128) comprising a pivot shank (1280) on which the Earth phase pipe (126) is fitted so as to rotate freely.

9. The watch (10) according to claim 1, wherein the display (110) on the Moon phase display device (11) and the mask (123) on the Earth phase display device (12) are rotated in opposite directions.
